(19) United States
(12) Patent Application Publication
(10) Pub. No.: US 2015/0192763 A1
(43) Pub. Date: Jul. 9, 2015

(54) COATINGS FOR USE WITH LONG WAVELENGTH DETECTION, OPTICAL SYSTEM INCLUDING THE SAME, AND ASSOCIATED METHODS

(71) Applicant: FLIR SYSTEMS, INC., Wilsonville, OR (US)

(72) Inventor: Saumya KOTHARI, Charlotte, NC (US)

(21) Appl. No.: 14/589,337

(22) Filed: Jan. 5, 2015

Related U.S. Application Data
(60) Provisional application No. 61/923,986, filed on Jan. 6, 2014.

(51) Int. Cl. G02B 13/14; G02B 5/20; H04N 5/33; G02B 1/11

(52) U.S. Cl. CPC G02B 13/14; G02B 1/11; G02B 5/208; H04N 5/33

(57) ABSTRACT

An imaging lens for use with an operational waveband over any subset of 7.5-13.5 μm, may include a first surface and a second surface, at least one of the first and second surfaces having optical power; an anti-reflection coating on one of the first and second surfaces; and a short wave cut filter on another one of the first and second surfaces, the short wave cut filter blocking wavelengths in a short wave infrared region. Details of the anti-reflection coating and the short wave cut filter are also provided.

### CROSS-REFERENCE TO RELATED APPLICATION

The present application claims priority under 35 U.S.C. §119(e) to U.S. Provisional Application No. 61/923,986, filed on Jan. 6, 2014, and entitled: “Coatings for Use with Long Wavelength Detection, Optical System Including the Same, and Associated Methods,” which is incorporated herein by reference in its entirety.

### BACKGROUND

1. Field

One or more embodiments described herein relate to coatings for use with long wavelength detection, an optical system including the same, and associated methods.

2. Description of the Related Art

Recent advances have allowed materials other than those traditionally used in the long wavelength region, e.g., 7.5 to 13.5 microns, to be employed for cameras. For example, as set forth in commonly owned U.S. patent application Ser. No. 13/835,188, which is hereby incorporated by reference, silicon can be used. While silicon has previously been deployed in thermopiles, silicon has not been able to provide resolution required for a thermographic camera. Use of silicon allows thermographic cameras to be fabricated using reliable and cost effective techniques. However, other issues may arise due to the use of silicon.

### SUMMARY

One or more embodiments is directed to an imaging lens for use with an operational waveband over any subset of 7.5-13.5 μM, the imaging lens including a first surface and a second surface, at least one of the first and second surfaces having optical power, an anti-reflection coating on one of the first and second surfaces, and a short wave cut filter on another one of the first and second surfaces, the short wave cut filter blocking wavelengths in a short wave infrared region.

The imaging lens may include a first optical element, the first surface being on the first optical element, and a second optical element, the second surface being on the first optical element.

The first surface may have the anti-reflection coating thereon and the second surface has the short wave cut filter thereon.

The first optical element may include a third surface, opposite the first surface, the third surface having the anti-reflection coating thereon.

The second optical element may include a fourth surface, opposite the second surface, the fourth surface having the short wave cut filter thereon.

The anti-reflection coating has a thickness between 1 and 4 microns. The anti-reflection coating may include five layers.

The anti-reflection coating may include at least one binding layer between a first layer and the one of the first and second surfaces and adjacent ones of first to fifth layers.

The short wave cut filter may have a thickness between 3 and 5.5 microns.

The e short wave cut filter may have more than ten layers.

The anti-reflection coating may include a plurality of layers, wherein a top and bottom layer of the plurality of layers is a same material.

The material may include zinc, e.g., zinc sulfide.

The first and second surfaces may be silicon.

The imaging lens may have a transmission of greater than 70% in the operational waveband and less than 1% over a wavelength region between 1.1 and 2 microns.

The imaging lens may have a transmission less than 1% over a wavelength region between 1.1 and 5 microns.

The imaging lens may have a transmission of less than 0.5% over a wavelength region between 1.1 and 2 microns.

One or more embodiments is directed to an anti-reflective coating for use on a silicon lens, including a first layer, a second layer, a third layer, a fourth layer, and a fifth layer, wherein the silicon lens having the anti-reflective coating on both sides thereof has an average reflectance at normal incidence of less than 1% in a wavelength range of 8500 nm to 12500 nm and an average transmittance at normal incidence of greater than 85% in a wavelength range of 8500 nm to 12500 nm.

A maximum thickness of the silicon lens may be between 0.3 mm and 2 mm.

The first, third, and fifth layers may be a first material. The first material may include zinc, e.g., zinc sulfide.

The second layer may be silicon and the fourth layer may be yttrium fluoride.

The first layer may have a thickness between 2000 and 3000 Å, the second layer may have a thickness between 1300 to 2300 Å, the third layer may have a thickness between 5200 to 5900 Å, the fourth layer may have a thickness between 8700 to 9400 Å, and the fifth layer may have a thickness between 2200 to 2800 Å.

The first to fifth layers may include at least two of zinc sulfide (ZnS), yttrium fluoride (YF₃), silicon (Si), zinc selenide (ZnSe), ytterbium fluoride (YbF₃), and germanium (Ge).

The first to fifth layers may include at least three of zinc sulfide (ZnS), yttrium fluoride (YF₃), silicon (Si), zinc selenide (ZnSe), ytterbium fluoride (YbF₃), and germanium (Ge).

The anti-reflective coating may have a total thickness between 1 and 4 microns, e.g., between 2 and 2.5 microns.

One or more embodiments is directed to a short wave cut filter for use with a silicon lens, including first to n layers of at least three materials, where n is greater than ten, wherein a first material of the at least three materials is alternated between other materials, wherein the silicon lens having the short wave cut filter on both surfaces thereof has an average transmittance of over 85% in in a wavelength range of 8000 nm to 12500 nm and less than 1% in the overall a wavelength range of 1100 to 2000 nm.

A maximum thickness of the silicon lens is between 0.3 mm and 2 mm.

The at least three materials may include zinc sulfide (ZnS), yttrium fluoride (YF₃), silicon (Si), zinc selenide (ZnSe), ytterbium fluoride (YbF₃), and germanium (Ge).

A total thickness of the short wave cut filter may be between 3 and 6 microns, e.g., between 4 and 5 microns.

The short wave cut filter may have an average transmittance of less than 1% in the overall a wavelength range of 1100 to 5000 nm.

The short wave cut filter may have a maximum transmittance of less than 0.5% in the overall a wavelength range of 1100 to 2000 nm.

The at least three may include a first material, a second material, and a third material, the first material being interleaved between the second and third materials.

The first material may include zinc, e.g., zinc sulfide.

The first layer may have a different material from the first material, e.g., may be Germanium.

One or more embodiments is directed to an imaging system for use with an operational waveband over any subset of 7.5-13.5 μm, the imaging system including a sensor and an imaging lens including a first surface and a second surface, at least one of the first and second surfaces having optical power, an anti-reflection coating on one of the first and second surfaces, and a short wave cut filter on another one of the first and second surfaces, the short wave cut filter blocking wavelengths in a short wave infrared region.

The imaging lens may be silicon.

The imaging system may include an additional imaging lens that is not silicon.

### BRIEF DESCRIPTION OF THE DRAWINGS

Features and advantages will become apparent to those of skill in the art by describing in detail exemplary embodiments with reference to the attached drawings, in which:

FIG. 1 illustrates a schematic cross-sectional view of an antireflective coating in accordance with an embodiment;

FIG. 2 illustrates a plot of transmission versus wavelength of an antireflective coating in accordance with an embodiment;

FIG. 3 illustrates a plot of reflectance versus wavelength of an antireflective coating in accordance with an embodiment;

FIG. 4 illustrates a schematic cross-sectional view of a shortwave cut filter in accordance with an embodiment;

FIG. 5 illustrates a plot of transmission versus wavelength of a shortwave cut filter in accordance with an embodiment;

FIG. 6 illustrates a schematic side view of an imaging capturing system in accordance with an embodiment; and

FIG. 7 illustrates a plot of transmission versus wavelength for an image capturing system having an anti-reflective coating and a shortwave cut filter.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete.

In using non-traditional materials, e.g., silicon, in the long wavelength region, e.g., 7.5 to 13.5 microns, implementation issues may arise. For example, polished silicon reflects approximately 30% of incident light in the long wavelength infrared region, which is much higher than that for materials typically used in thermography. Further, use of silicon may result in detector burn, i.e., the silicon may transmit too strong a signal outside a range to be detected, particularly in the short wavelength infrared region, e.g., 1.1-5, e.g., 1-2, for detectors in the long wavelength region. In contrast, typical materials used in thermography block most of the short wavelength infrared region. Embodiments are directed to addressing one or more of these issues. When referring to coatings having multi-layer structures, as described in detail below, it is to be understood that additional layers, e.g., for improving binding, that only negligibly contribute to the overall optical performance of the coating are excluded from the tally of layers and the thicknesses thereof. The coating described below may be used, for example, with a silicon substrate, e.g., a silicon lens element, having a maximum thickness between 0.3 and 2.0 mm.

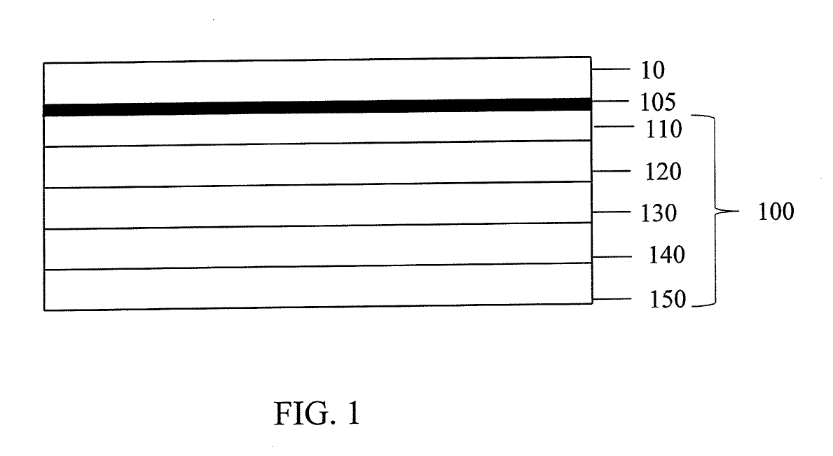

FIG. 1 is a schematic cross-sectional view of an antireflective (AR) coating 100 in accordance with an embodiment. As shown therein, the antireflective coating 100 may include five layers 110-150 on a substrate 10, e.g., a silicon substrate. A binding layer 105 may be provided between the first layer 110 and the substrate 10. Additionally or alternatively, a binding layer may be provided between the any of the adjacent layers 110-150. The binding layer(s) may be an order of magnitude thinner than the five layers 110-150, e.g., on the order of tens of Å.

The antireflective coating 100 may be made of two or three different materials and may have a thickness between about 1 to 4 microns. These layers may be provided, e.g., deposited using electron beam evaporation, in alternating layers. Examples of the different materials include zinc sulfide (ZnS), yttrium fluoride (YF₃), silicon (Si), zinc selenide (ZnSe), ytterbium fluoride (YbF₃), and germanium (Ge). For example, first layer 110 may be ZnS having a thickness from 2000 Å to 3000 Å, second layer 120 may be Si having a thickness from 1300 to 2300 Å, third layer 130 may be ZnS having a thickness from 5200 to 5900 Å, fourth layer 140 may be YF₃ having a thickness from 8700 to 9400 Å, and fifth layer 150 may be ZnS having thickness from 2200 to 2800 Å.

As a more specific example, the first layer 110 may be a ZnS layer having a thickness of about 2650 Å, the second layer 120 may be a silicon layer having a thickness of about 2000 Å, the third layer 130 may be a ZnS layer having a thickness of about 5350 Å, the fourth layer 140 may be a YF₃ layer having a thickness of about 8900 Å, and the fifth layer 150 may be a ZnS layer having a thickness of about 2200 Å.

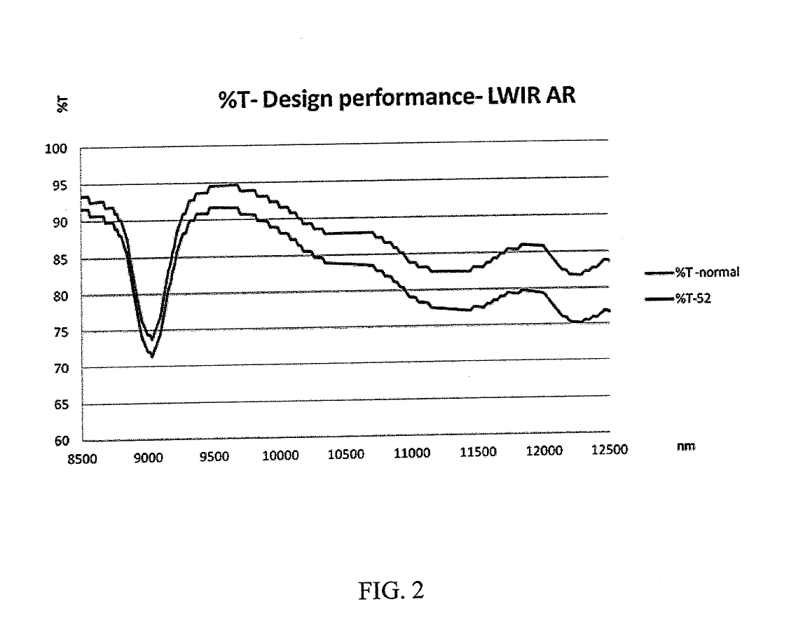

FIG. 2 is a plot of transmission versus wavelength for a substrate having a thickness of 0.7 mm and having the above specific AR coating on both sides thereof. An average transmittance over the range of 8500 to 12500 nm is 86.96% for light incident on axis, i.e., normal to the substrate, and 82.665% for light incident at a 52° angle to the substrate.

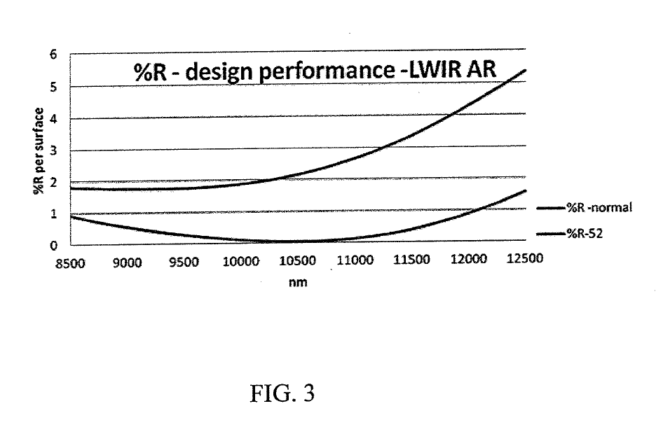

FIG. 3 is a plot of reflectance versus wavelength for a substrate having a thickness of 0.7 mm and having the above specific AR coating on both surfaces thereof. An average reflectance over the range of 8500 to 12500 nm is 0.425% for light incident on axis, i.e., normal to the substrate, and 2.66% for light incident at a 52° angle to the substrate.

From the above, it may be seen that the antireflective coating 100 may provide an on axis performance of greater than 85% transmittance and less the 1% reflection.

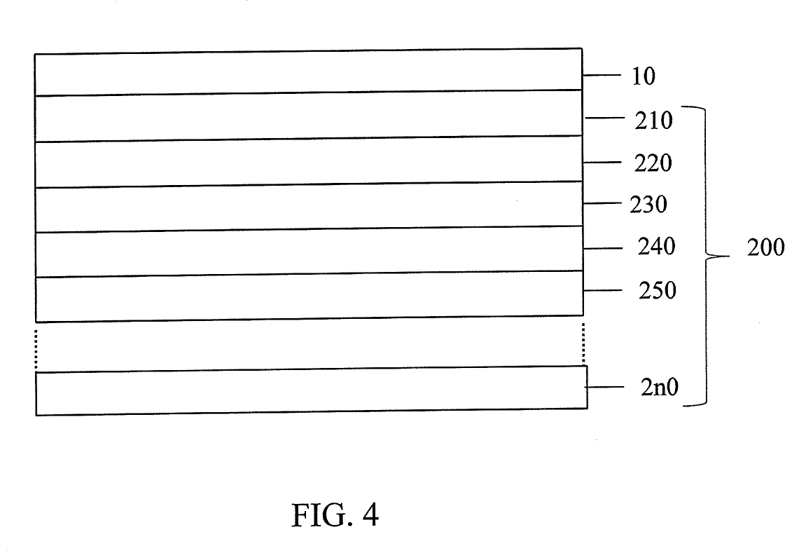

FIG. 4 is a schematic cross-sectional view of a shortwave cut filter 200 in accordance with an embodiment. The shortwave cut filter 200, also known as a long pass filter, blocks light outside the LWIR region, particularly light to which an LWIR sensor may be very sensitive, e.g., from 1.1 to 5 microns, more particularly between 1.1 and 2 microns. As discussed above in connection with the anti-reflective coating, binding layer(s) may be provided between the filter 200 and the substrate 10 or between adjacent layers in the stack.

As shown in FIG. 4, the shortwave cut filter 200 may include a plurality “n” of layers 210-2n0 on the substrate 10, e.g., a silicon substrate. Examples of the different materials include zinc sulfide (ZnS), yttrium fluoride (YF₃), silicon (Si), zinc selenide (ZnSe), ytterbium fluoride (YbF₃), and germanium (Ge). Three materials may be provided on, e.g., deposited using electron beam evaporation, the substrate 10 in alternating layers. For example, a first material may be interleaved between the second and third materials.

In particular, shortwave cut filter 200 may include n multiple layers, e.g., greater than ten layers, of zinc sulfide (ZnS), germanium (Ge), and yitrium fluoride (YF₃). The first layer 210 may be Ge and the last layer 2n0 may be Zns. The remaining layers may be one of Ge and YF₃ with a ZnS layer in between. A total thickness of the shortwave cut filter 200 may be between 3 and 6 microns.

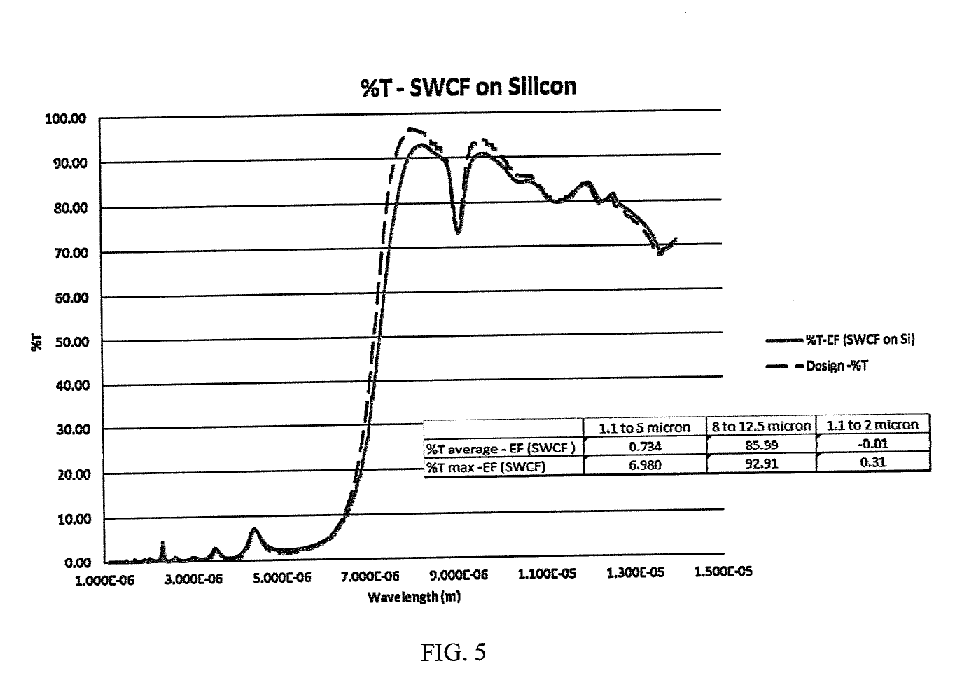

FIG. 5 is a plot of transmission versus wavelength for a silicon substrate having thicknesses of 0.7 mm with the particular shortwave cut filter 200 having a total of 26 layers and a thickness of 4.5 microns provided on both sides of the substrate. The thicknesses and materials for this specific example are provided in Table 1 below.

TABLE 1

| Layer | Material | Thickness (Å) |
|---|---|---|
| 1 | Ge | 1518 |
| 2 | ZnS | 792 |
| 3 | YF₃ | 1029 |
| 4 | ZnS | 200 |
| 5 | Ge | 2389 |
| 6 | ZnS | 390 |
| 7 | YF₃ | 2147 |
| 8 | ZnS | 475 |
| 9 | Ge | 2722 |
| 10 | ZnS | 406 |
| 11 | YF₃ | 2382 |
| 12 | ZnS | 298 |
| 13 | Ge | 1532 |
| 14 | ZnS | 287 |
| 15 | YF₃ | 2389 |
| 16 | ZnS | 333 |
| 17 | Ge | 2939 |
| 18 | ZnS | 353 |
| 19 | YF₃ | 1920 |
| 20 | ZnS | 3092 |
| 21 | Ge | 3820 |
| 22 | ZnS | 500 |
| 23 | YF₃ | 1920 |
| 24 | ZnS | 2200 |
| 25 | YF₃ | 300 |
| 26 | ZnS | 2000 |

The result for this coating on substrates having thicknesses of 0.7 mm is summarized below in Tables 2, respectively.

TABLE 2

| | 1.1 to 5 microns | 1.1 to 2 microns | 8 to 12.5 microns |
|---|---|---|---|
| % T average | 0.734 | −0.01 | 85.96 |
| % T max | 6.98 | 0.31 | 92.91 |

As can be seen therein, in addition to blocking undesired wavelength, e.g., less than 1% transmittance in the short and mid IR regions, e.g., 1.1 to 5 μm, the use of the short wave cut coating on both sides of the substrate also improves transmission from about 52% to a maximum transmittance of over 92% and an average transmittance over 85% in the LWIR region compared to a bare substrate.

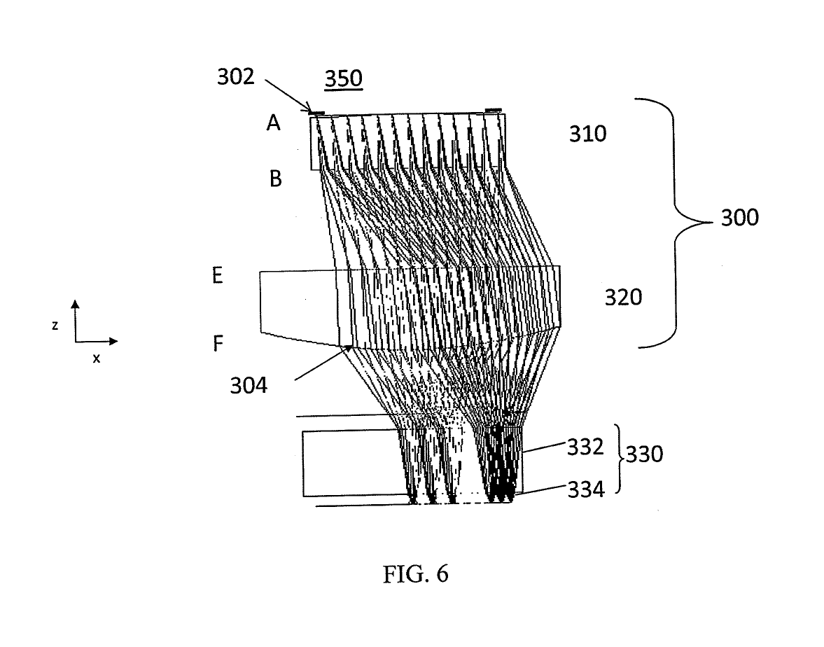

FIG. 6 illustrates a schematic side view of an image capturing system 350 in the LWIR waveband in accordance with an embodiment. As illustrated in FIG. 6, the image capturing system 350 includes an imaging lens 300 and a sensor 330.

The imaging lens 300 may include a first optical element 310 and a second optical element 320. In the schematic illustration of FIG. 6, a spacer (which would include surfaces C and D) between the first optical element 310 and the second optical element 320 has been omitted for clarity.

In this particular embodiment, both the first optical element 310 and the second optical element 320 are planoconvex lenses. A surface A, here an input surface of the imaging lens 300, of the first optical element 310 and a surface F, here a final surface of the imaging lens 300, both have optical power. One or both of these surfaces may be aspheric. Surface B of the first optical element 310 and surface E of the second optical element 320 have no optical power, here are both planar, and face each other. The first optical element 310 and/or the second optical element 320 may be silicon.

The imaging lens 300 may also include an aperture stop 302. For example, the aperture stop 302 may be adjacent surface A, e.g., directly on surface A, of the first optical element 110. The aperture stop 302 may be made of metal, e.g., chromium, a dyed polymer, or any suitable material that is opaque to LWIR. The aperture stop 302 may be at any appropriate location within the imaging lens 300. The aperture stop 302 may be thin, e.g., have a thickness of less than 200 nm, but thick enough to be effective, i.e., have a transmission there through of less than about 0.5% in the operational waveband. The f-number for the imaging lens 300 may be less than 1.1.

If the material used for one or both optical elements 310, 320 presents chromatic dispersion over an operational waveband or if the imaging lens 300 otherwise requires correction, a diffractive element 304 may be provided on one or more of the surfaces A, B, E, or F. For example, the diffractive element 304 may be on the surface having the most optical power, here, surface F.

The sensor 330 may include a sensor cover glass 332 and pixels in a sensor image plane 334, the pixels detecting LWIR radiation. The sensor cover glass 332 may be made of silicon and may have a thickness between 0.5 mm and 1.0 mm. The working distance of the image capturing system 350 is a distance from a bottom surface, i.e., an apex of the bottom surface, of the imaging lens 300, here surface F, to a top surface of the cover glass 332. The optical track length of the imaging capturing system 350 is a distance from an apex of the first surface of the imaging lens 300, here surface A, to the sensor image plane 334.

The above AR and SWC coatings may be applied to various ones of the surfaces that are in the optical path, here, A, B, E and F surfaces. For example, the AR coating may be provided on the A surface and the SWC coating may be provided on a B surface. As another example, the ARC coating may be provided on both the A and B surfaces and the SWC may be provided on both the E and F surfaces.

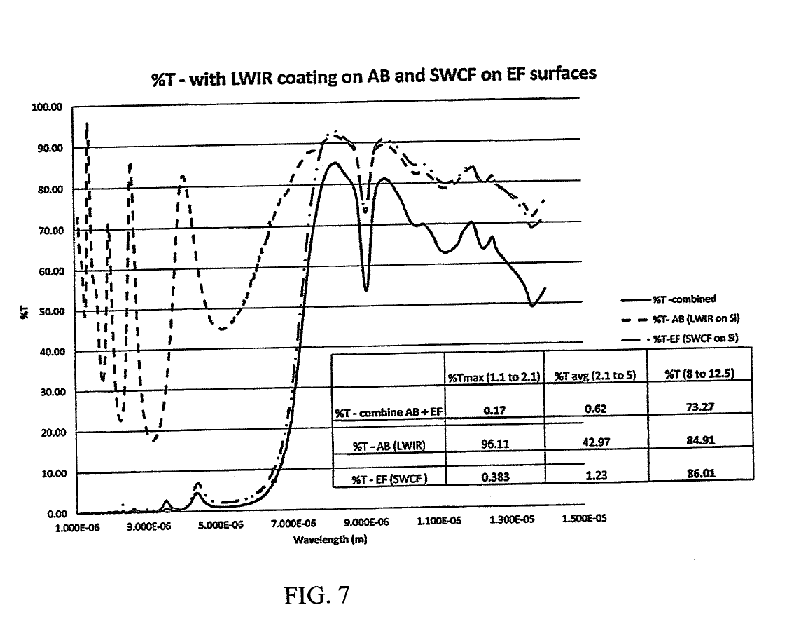

FIG. 7 illustrates a plot of transmission versus wavelength for an image capturing system having two optical elements, with the AR coating on the A and B surfaces and with the short wave cut filter on the E and F surfaces. As can be seen therein, use of both of these filters allows a significant reduction in the amount of light outside the LWIR waveband, particularly in the short and mid IR waveband, being transmitted, e.g., to less than 1% average transmission, even more particularly over the waveband from 1.1 to 2 micron, e.g., to less than 0.5% maximum transmission, while maintaining average transmission in the LWIR waveband to above 70%.

By way of summation and review, embodiments provide coatings that address unique problems that arise when employing optical materials, e.g., silicon, in thermographic cameras. While the above examples have provided a same coating on both surfaces of a silicon substrate, e.g., a silicon lens, the silicon substrate may have a coating on only one surface thereof, or may have different coatings, e.g., an anti-reflective coating and a short wave cut filter, on different surfaces thereof. Further, while the above designs used all silicon lenses, a silicon lens could be used in conjunction with a more traditional material for LWIR imaging, e.g., germanium (Ge), chalcogenide glass, zinc selenide (ZnSe), zinc sulfide (ZnS), and so forth.

As used herein, the term “and/or” includes any and all combinations of one or more of the associated listed items. Further, although terms such as “first,” “second,” “third,” etc., may be used herein to describe various elements, components, regions, layers and/or sections, these elements, components, regions, layers and/or sections should not be limited by these terms. These terms are only used to distinguish one element, component, region, layer and/or section from another. Thus, a first element, component, region, layer and/or section could be termed a second element, component, region, layer and/or section without departing from the teachings of the embodiments described herein.

Spatially relative terms, such as “beneath,” “below,” “lower,” “above,” “upper,” etc., may be used herein for ease of description to describe the relationship of one element or feature to another element(s) or feature(s), as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

As used herein, the singular forms “a,” “an” and “the” are intended to include the plural forms as well, unless the context clearly indicates otherwise. It will be further understood that the terms “comprises,” “comprising,” “includes,” and “including” specify the presence of stated features, integers, steps, operations, elements, components, etc., but do not preclude the presence or addition thereto of one or more other features, integers, steps, operations, elements, components, groups, etc.

Embodiments of the present invention have been disclosed herein and, although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the present invention as set forth in the following claims.

1. An imaging lens for use with an operational waveband over any subset of 7.5-13.5 μm, the imaging lens comprising:
a first surface and a second surface, at least one of the first and second surfaces having optical power;
an anti-reflection coating on one of the first and second surfaces; and
a short wave cut filter on another one of the first and second surfaces, the short wave cut filter blocking wavelengths in a short wave infrared region.

2. The imaging lens as claimed in claim 1, wherein the imaging lens includes:
a first optical element, the first surface being on the first optical element; and
a second optical element, the second surface being on the first optical element.

3. The imaging lens as claimed in claim 2, wherein the first surface has the anti-reflection coating thereon and the second surface has the short wave cut filter thereon.

4. The imaging lens as claimed in claim 3, wherein the first optical element includes a third surface, opposite the first surface, the third surface having the anti-reflection coating thereon.

5. The imaging lens as claimed in claim 4, wherein the second optical element includes a fourth surface, opposite the second surface, the fourth surface having the short wave cut filter thereon.

6. The imaging lens as claimed in claim 1, wherein the anti-reflection coating has a thickness between 1 and 4 microns.

7. The imaging lens as claimed in claim 1, wherein the anti-reflection coating includes five layers.

8. The imaging lens as claimed in claim 7, further comprising at least one binding layer between a first layer and the one of the first and second surfaces and adjacent ones of first to fifth layers.

9. The imaging lens as claimed in claim 1, wherein the short wave cut filter has a thickness between 3 and 5.5 microns.

10. The imaging lens as claimed in claim 1, wherein the short wave cut filter has more than ten layers.

11. The imaging lens as claimed in claim 1, wherein the anti-reflection coating includes a plurality of layers, wherein a top and bottom layer of the plurality of layers is a same material.

12. The imaging lens as claimed in claim 11, wherein the material includes zinc.

13. The imaging lens as claimed in claim 12, wherein the material is zinc sulfide.

14. The imaging lens as claimed in claim 1, wherein the first and second surfaces are silicon.

15. The imaging lens as claimed in claim 1, wherein the imaging lens has a transmission of greater than 70% in the operational waveband and less than 1% over a wavelength region between 1.1 and 2 microns.

16. The imaging lens as claimed in claim 15, wherein the imaging lens has a transmission less than 1% over a wavelength region between 1.1 and 5 microns.

17. The imaging lens as claimed in claim 15, wherein the imaging lens has a transmission of less than 0.5% over a wavelength region between 1.1 and 2 microns.

18-40. (canceled)

41. An imaging system for use with an operational waveband over any subset of 7.5-13.5 μm, the imaging system comprising:
a sensor; and
an imaging lens including:
a first surface and a second surface, at least one of the first and second surfaces having optical power;
an anti-reflection coating on one of the first and second surfaces; and
a short wave cut filter on another one of the first and second surfaces, the short wave cut filter blocking wavelengths in a short wave infrared region.

42. The imaging system as claimed in claim 41, wherein the imaging lens is silicon.

43. The imaging system as claimed in claim 42, further comprising an additional imaging lens that is not silicon.
